(19) United States
(12) Patent Application Publication
(10) Pub. No.: US 2006/0232402 A1
(43) Pub. Date: Oct. 19, 2006

(54) Remote pager

(76) Inventor: Manuel M. Martinez, Danbury, CT (US)

Correspondence Address: Manuel Martinez, 8 Beech Street, Danbury, CT, 06810, US

(21) Appl. No.: 11/108,127

(22) Filed: Apr. 18, 2005

(51) Int. Cl. G08B 1/08

(52) U.S. Cl. 340/539.32; 340/825.49

(57) ABSTRACT

The remote pager is a new way of being able to locate your TV's remote control when it's lost (whether it's in the couch or it's in the next room) without spending valuable time searching for it.

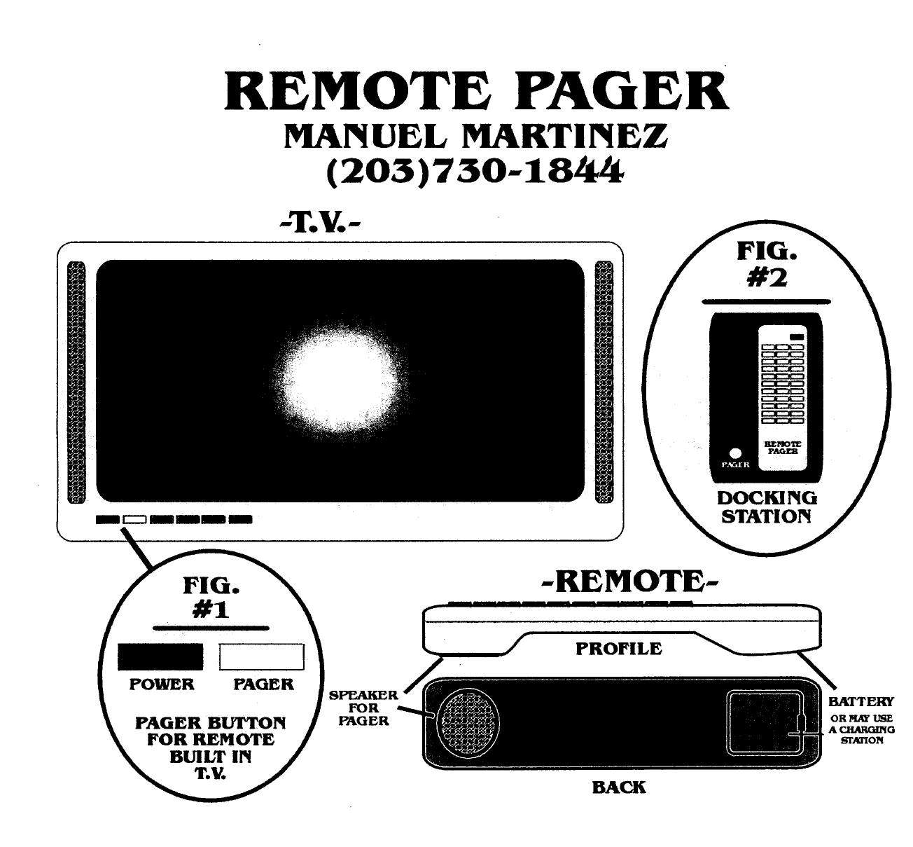

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The remote-pager is a remote control in which the remote itself has a paging device built into it, similar to a cordless phone pager.

### BRIEF SUMMARY OF THE INVENTION

The remote pager is a beeping device that allows you to locate the television's remote control in the event it's misplaced.

### BRIEF DESCRIPTION OF THE SEVERAL VIEWS OF THE DRAWING

FIG. #1: the remote control is sold with the TV and the pager button is built into the TV itself.

FIG. #2: the remote control is sold as a universal remote with a pager button that is located on a docking station for the remote.

1. What I claim as my invention is to create a remote control that can be paged;
By a button either built into the TV itself; or
Built onto a docking station for the remote.
